(19) United States
(12) Patent Application Publication
(10) Pub. No.: US 2025/0370305 A1
(43) Pub. Date: Dec. 4, 2025

(54) VARIABLE DIMMING ELECTROCHROMIC PANEL

(71) Applicant: Rockwell Collins, Inc., Cedar Rapids, IA (US)

(72) Inventors: Joshua Buhr, Marion, IA (US); Christopher M. Biggers, North Liberty, IA (US)

(21) Appl. No.: 18/675,948

(22) Filed: May 28, 2024

(51) Int. Cl. G02F 1/163; B64C 1/14; B64D 47/08; G02B 27/01; G06F 3/01

(52) U.S. Cl. CPC G02F 1/163; B64C 1/1484; B64D 47/08; G02B 27/0101; G06F 3/013; G02B 2027/0118

(57) ABSTRACT

A system includes a first camera located within a cockpit of an aircraft to track the eye movement of at least one pilot, and a second camera to track an ambient light source. The system includes an electrochromic panel having an array of dimmable cells. The system further includes a controller, equipped with one or more processors responsible for modifying the array of dimmable cells. The controller receives eye tracking data from the first camera associated with a gaze target of the pilot, and light tracking data from the second camera, which includes parameters associated with the ambient light source. Based on the eye tracking and light tracking data, the controller determines a glare location on a surface of the electrochromic panel where the gaze target intersects. The controller may then selectively modify a tint level of specific dimmable cells in the panel to address the determined glare location.

### TECHNICAL FIELD

The present invention generally relates to light transmission systems and, more particularly, to a system and method employing a variable dimming electrochromic panel.

### BACKGROUND

Electrochromic material technology provides the ability to dim transparent surfaces by applying an electric potential across the electrochromic material. For example, electrochromic materials are used on aircraft windows to dim the light from the sun to shield an observer within the aircraft looking at or out of the window.

Solid state lighting displays may be dimmed by adjusting the current to the light sources of the display. For example, for a liquid crystal display (LCD) having light emitting diodes (LEDs) as light sources, the brightness of the LEDs is adjusted, and thus the display brightness is correspondingly varied. There are different schemes for adjusting the brightness of the light sources of the display. One scheme is amplitude modulation where current to the LEDs is adjusted to vary their brightness. Another scheme is pulse width modulation where current or power to the LEDs is turned on or off at different times in order to vary the brightness of the LEDs. Amplitude modulation and pulse width modulation can be used in unison to increase the dynamic range of the brightness variation.

Solid state light devices require a minimum amount of current in order to operate, and thus a minimum brightness can be achieved by driving the device to the minimum current for the minimum amount of time. As solid-state lighting becomes more efficient, the amount of brightness per unit power or current increases. This has the impact of making it more difficult to dim the light source as solid-state lighting becomes more efficient. The low-end brightness levels are no longer achievable because the solid-state device will not turn on to provide the low-end brightness levels, or the solid state device is too unstable at extremely low currents. In systems where extremely high brightness is required, one cannot simply decrease the optical system efficiency in order to counteract this effect because high optical system efficiency is required to achieve the high brightness levels at a reasonable LED input. In certain applications it is possible to reduce the number of solid-state light sources in order to reduce the amount of light, but other considerations such as display uniformity, system efficiency, and heat dissipation all become tradeoffs in certain applications.

### SUMMARY

A system is disclosed, in accordance with one or more embodiments of the present disclosure. In some embodiments, the system includes a first camera disposed within a cockpit of an aircraft, the first camera configured to track an eye movement of at least one pilot. In some embodiments, the system includes a second camera disposed within the cockpit of the aircraft, the second camera configured to at least track an ambient light source. In some embodiments, the system includes an electrochromic panel including an array of dimmable cells disposed throughout the electrochromic panel, where the electrochromic panel is configured to couple to at least a portion of a window. In some embodiments, the system includes a controller configured to modify the array of dimmable cells. In embodiments, the controller includes one or more processors configured to execute program instructions stored in memory. In embodiments, the one or more program instructions are configured to cause the one or more processors to receive eye tracking data via the first camera, where the eye tracking data comprises one or more parameters associated with a gaze target of the at least one pilot positioned within the cockpit. In embodiments, the one or more program instructions are configured to cause the one or more processors to receive light tracking data via the second camera, where the light tracking data comprises one or more parameters associated with the ambient light source. In embodiments, the one or more program instructions are configured to cause the one or more processors to determine a glare location on a surface of the electrochromic panel where at least the gaze target intersects the electrochromic panel, based on at least one of the received eye tracking data or the light tracking data. In embodiments, the one or more program instructions are configured to cause the one or more processors to selectively modify a tint level of at least some of the array of dimmable cells in a portion of the electrochromic panel in response to at least the determined glare location.

A method is disclosed, in accordance with one or more embodiments of the present disclosure. In some embodiments, the method may include, but is not limited to, providing an electrochromic panel including an array of dimmable cells disposed throughout the electrochromic panel, where the electrochromic panel is configured to couple to at least a portion of a window within a cockpit of an aircraft. In some embodiments, the method may include, but is not limited to, receiving eye tracking data via a first camera, where the eye tracking data comprises one or more parameters associated with a gaze target of at least one pilot positioned within a cockpit of an aircraft. In some embodiments, the method may include, but is not limited to, receiving light tracking data via a second camera, where the light tracking data comprises one or more parameters associated with an ambient light source. In some embodiments, the method may include, but is not limited to, determining a glare location on a surface of the electrochromic panel based on at least the intersection point between the gaze target and the electrochromic panel. In some embodiments, the method may include, but is not limited to, selectively modify a tint level of at least some of the array of dimmable cells in at least a portion of the panel in response to at least the determined glare location.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a system providing a variable dimming electrochromic panel integrated within a cockpit of an aircraft, in accordance one or more embodiments of the present disclosure.

FIG. 2 illustrates a simplified block diagram of a system providing a variable dimming electrochromic panel, in accordance with one or more embodiments of the present disclosure.

FIG. 3A illustrates a perspective view of the electrochromic panel configured in a transmittance mode, in accordance with one or more embodiments of the present disclosure.

FIG. 3B illustrates a perspective view of the electrochromic panel configured in a reflection mode, in accordance with one or more embodiments of the present disclosure.

FIG. 4 illustrates a flowchart of a method for selectively modifying a tint level of an electrochromic panel, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Embodiments of the inventive concepts disclosed herein are directed to a system and method providing a variable dimming electrochromic panel for alleviating sun glare. Sun glare, within cockpit environments, may impact pilot safety, comfort, and operational efficiency. For example, glare from the sun can create a host of issues, from hindering pre-flight checks to obscuring critical instrument readings during flight. Existing technologies, such as polarized sunglasses and sun visors, offer partial mitigation but fail to provide comprehensive solutions.

In embodiments, the variable dimming electrochromic panel responds to the challenges mentioned above by leveraging electrochromic panel technology in conjunction with advanced sensing and processing capabilities. For example, the system may offer dynamic glare reduction tailored to the specific needs of pilots in varying lighting conditions. Further, through the integration of eye-tracking and sun-tracking cameras, along with computational analysis, the system may autonomously adjust the tint levels of the panel to optimize visibility while minimizing glare.

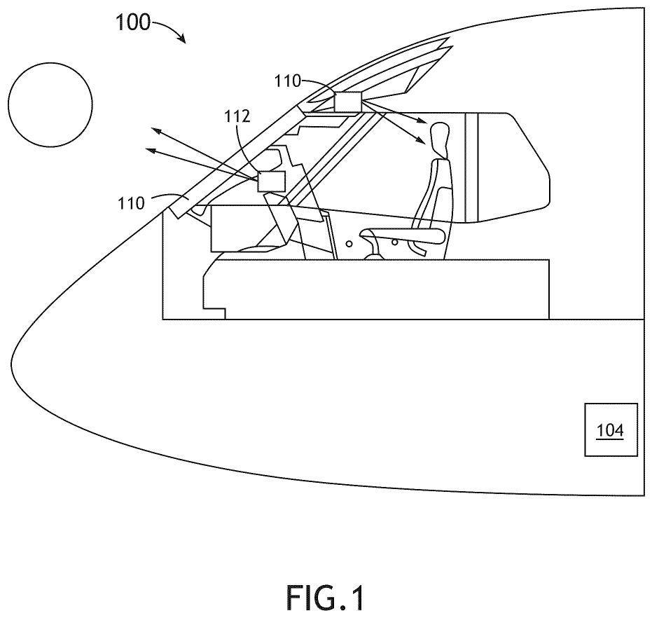

FIG. 1 illustrates a system 100 providing a variable dimming electrochromic panel 102 integrated within a cockpit of an aircraft, in accordance one or more embodiments of the present disclosure.

In embodiments, the system 100 includes an electrochromic panel 102 configured to couple to a transparent or semi-transparent surface within the cockpit. For example, the electrochromic panel 102 may be configured to attach directly to cockpit windows (e.g., a windshield). By way of another example, the electrochromic panel 102 may be configured to attach to at least one of an instrumentation display, a multifunction display (MFD), a head-up display (HUD), a touchscreen display, an LED indicator panel, and the like. It is noted herein that by attaching the electrochromic panel 102 to various types of displays and cockpit windows, cockpit visibility, readability, and functionality may be significantly improved.

It is further noted herein that the electrochromic panel 102 may be configured to couple to a helmet-mounted display, a head-worn display (HWD), a vehicle-mounted display (e.g., aircraft cockpit display, automobile display), and a mobile device display (e.g., smart phone display, handheld display, smart watch display, and the like). In this regard, while much of the present disclosure is directed to a system 100 in the context of an aircraft environment (e.g., aircraft cockpit display, HUD, HMD, HWD, and the like), it is contemplated herein that embodiments of the present disclosure may be applied to display devices in contexts other than aircraft environments.

In embodiments, the electrochromic panel 102 is configured to couple to the display via an adhesive mounting, a clamp mounting, a frame integration, a magnetic mounting, a bracket mounting, a hinge integration, or the like.

In embodiments, the system 100 includes a first camera 110 configured as an eye tracking camera 110. For example, the eye tracking camera 110 may be mounted or fixed within the cockpit and aligned with the eyes of the pilot.

The eye tracking camera 110 may include a lens system capable of capturing detailed images of the eyes of the pilot. The lens system may include multiple lenses to optimize at least one of a focal length, depth of field, and field of view for reliable eye tracking performance. By way of another example, the eye tracking camera 110 may include an image sensor configured to convert incoming light into digital signals. For instance, the sensitivity and dynamic range of the image sensor may be calibrated to ensure accurate detection and tracking of the eye movements of the pilot across a wide range of lighting conditions. By way of another example, the eye tracking camera 110 may include infrared (IR) illuminators incorporated into the camera 110 to enhance visibility and tracking accuracy, particularly in low-light or nighttime conditions. The IR illuminators may emit invisible infrared light that illuminates the eyes of the pilot without causing discomfort or distraction.

In embodiments, the first camera 110 includes a tracking mechanism. For instance, the tracking mechanism may include a gaze detection algorithm to analyze the captured images and identify key features of the eyes of the pilot, such as the pupils, iris, and eye corners. Such algorithms may employ image processing techniques including, but not limited to, edge detection, pattern recognition, and machine learning, to accurately track the position, movement, and orientation of the eyes in real-time.

It is noted herein that the tracking mechanism may include, but is not limited to, an eye position calibration to help establish a baseline reference for the eyes of the pilot within the field of view of the camera 110, and an accuracy tracker to validate the accuracy of the tracking measurements.

In embodiments, the eye tracking camera 110 may play a role in glare mitigation by providing real-time feedback on the gaze behavior and eye movements of the pilot. For example, the information may allow the variable dimming electrochromic panel system 100 to dynamically adjust tint levels to minimize glare and optimize visibility based on the viewing angle and preferences of the pilot. By way of another example, the eye tracking camera 110 may support various user interaction functionalities, such as gaze-based control and interface navigation. By tracking the gaze of the pilot, the eye tracking camera 110 may enable hands-free interaction with cockpit displays, controls, and avionics systems, enhancing operational efficiency and pilot workload management.

In embodiments, the eye tracking camera 110 may serve as a biometric monitoring tool, providing valuable insights into the physiological state and cognitive workload of the pilot. Through analyzing parameters such as blink rate, pupil dilation, and fixation duration, the camera 110 may assess the level of alertness, fatigue, and attentional focus.

In embodiments, the second camera 112 of the system 100 may include a light source tracking camera 112. For example, the light source camera 112 may be configured to accurately detect and track the position, movement, and characteristics of external light sources such as, but not limited to, the sun and the moon. The light source tracking camera 112 may be positioned within the cockpit such that it provides real-time data on the orientation, intensity, and directionality of external light sources.

In embodiments, the light source tracking camera 112 includes at least one of a lens system, an image sensor, and a filtering mechanism. For example, the lens system may be configured to capture images of external light sources with an enhanced clarity and precision. By way of another example, the lens system may include multiple lenses to adjust focal length, depth of field, and field of view for optimal tracking performance.

The image sensor may be configured to convert incoming light into digital signals. For example, the high resolution, sensitivity and dynamic range of the image sensor may provide accurate detection and analysis of external light sources under varying lighting conditions.

The filtering mechanism may include optical filters which may be incorporated into the camera 112 to selectively block or enhance specific wavelengths of light, such as infrared or ultraviolet radiation. These filters help improve the sensitivity to relevant light sources of camera 112 while minimizing interference from ambient light.

In embodiments, the light source tracking camera 112 is configured to track the sun via the one or more processors 106. For example, the one or more processors 106 may be configured to enable the light source tracking camera 112 to track the sun by performing a sun position detection, a light intensity measurement, and an angular velocity estimation. For instance, the sun position may be detected by identifying key features of the solar disk or solar corona in captured images. By way of another example, the light intensity measurement may be measured within a field of view of the camera 112. In a further example, the angular velocity estimation serves to monitor changes in the apparent position of the sun over time, in which, the one or more processors 106 estimate the angular velocity of the movement of the sun across the sky. It is noted herein, the light source tracking camera 112 may be utilized to predict glare, compensate for a sun angle, or monitoring external lighting conditions.

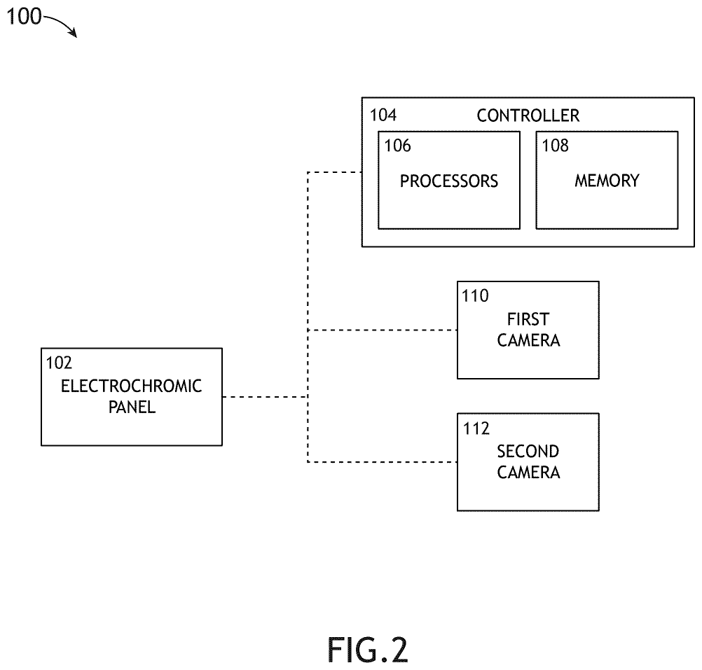

FIG. 2 illustrates a simplified block diagram of a system 100 providing a variable dimming electrochromic panel 102, in accordance with one or more embodiments of the present disclosure. The system 100 may include, but is not limited to, an electrochromic panel 102, a controller 104, one or more processors 106, and a memory 108. In embodiments, the system 100 further includes a first camera 110 and a second camera 112.

It is noted herein that the one or more components of the system 100 may be communicatively coupled to the various other components of the system 100 in any manner known in the art. For example, the electrochromic panel 102, the controller 104, the one or more processors 106, the memory 108, the first camera 110, and/or the second camera 112 may be communicatively coupled to each other and other components via a wireline (e.g., copper wire, fiber optic cable, and the like) or wireless connection (e.g., RF coupling, IR coupling, WiFi, WiMax, Bluetooth, 3G, 4G, 4G LTE, 5G, and the like).

In embodiments, the one or more processors 106 may include any one or more processing elements known in the art. In this sense, the one or more processors 106 may include any microprocessor-type device configured to execute software algorithms and/or instructions. In one embodiment, the one or more processors 106 may consist of a desktop computer, mainframe computer system, workstation, image computer, parallel processor, a field-programmable gate array (FPGA), multi-processor system-on-chip (MPSoC), or other computer system (e.g., networked computer) configured to execute a program configured to operate the variable dimming electrochromic panel system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from memory 108. Moreover, different subsystems of the system 100 (e.g., electrochromic panel 102, first camera 110, second camera 112) may include one or more processor or logic elements suitable for carrying out at least a portion of the steps described throughout the present disclosure. Therefore, the above description should not be interpreted as a limitation on the present disclosure but merely an illustration.

The memory 108 may include any storage medium known in the art suitable for storing program instructions executable by the associated one or more processors 106. For example, the memory 108 may include a non-transitory memory medium. For instance, the memory 108 may include, but is not limited to, a read-only memory (ROM), a random-access memory (RAM), a magnetic or optical memory device (e.g., disk), a magnetic tape, a solid-state drive and the like. It is further noted that memory 108 may be housed in a common controller housing with the one or more processors 106. In an alternative embodiment, the memory 108 may be located remotely with respect to the physical location of the processors 106 and controller 104. In another embodiment, the memory 108 maintains program instructions for causing the one or more processors 106 to carry out the various steps described through the present disclosure.

The one or more processors 106 may be configured to execute a set of program instructions stored in memory 108, the set of program instructions configured to cause the one or more processors 106 to carry out one or more steps of the present disclosure. For example, the one or more processors 106 of the controller 104 may be configured to receive eye tracking data via the first camera 110, where the eye tracking data comprises one or more parameters associated with a gaze target of a pilot positioned within the cockpit. By way of another example, the one or more processors 106 of the controller 104 may receive light tracking data via the second camera 112, where the light tracking data comprises one or more parameters associated with an ambient light source. By way of another example, the one or more processors 106 of the controller 104 may determine a glare location on a surface of the panel 102 where at least the gaze target intersects the panel 102, based on at least one of the received eye tracking data or the light tracking data; and selectively modify a tint level of at least some of the array of dimmable cells in at least a portion of the panel 102 in response to at least the determined glare location. Each of the various steps/functions performed by the one or more processors 106 of the controller 104 will be discussed in further detail herein.

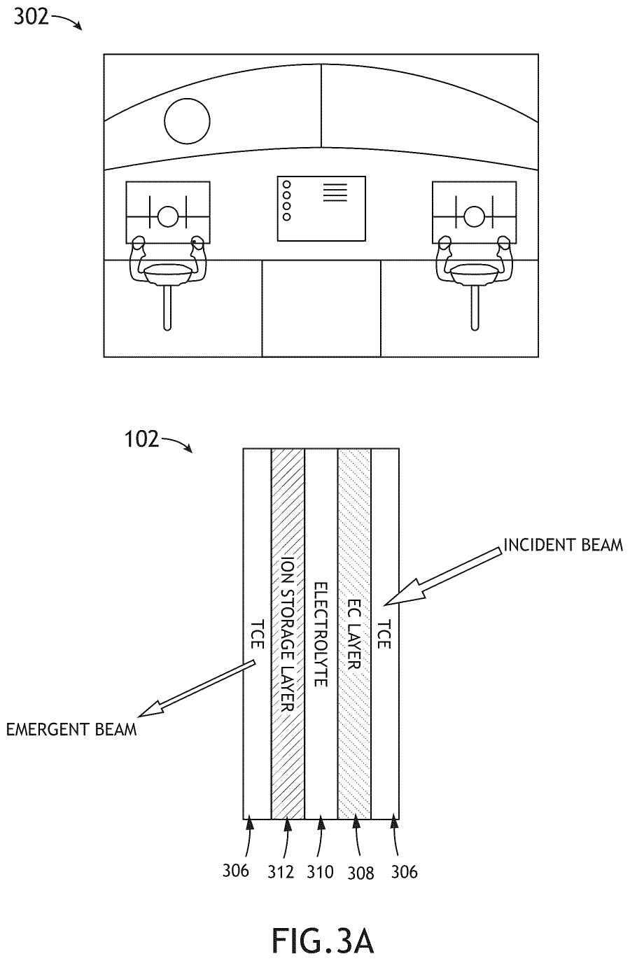

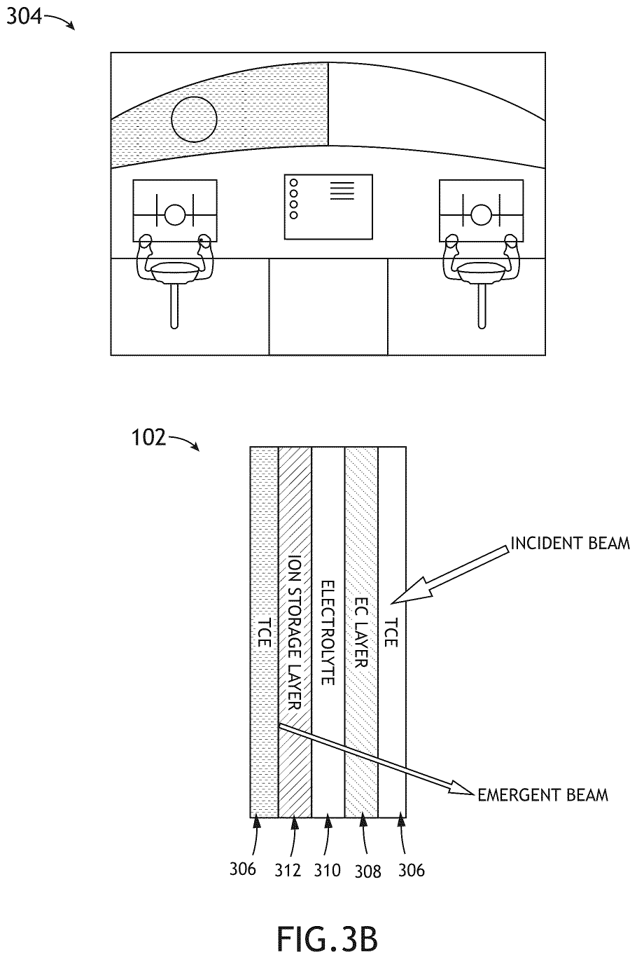

FIGS. 3A through 3B illustrate perspective views of the electrochromic panel 102 configured in a transmittance mode 302 and a reflection mode 304, in accordance with one or more embodiments of the present disclosure.

In embodiments, the electrochromic panel 102 comprises a plurality of layers stacked between two transparent conductive electrodes. For example, the two transparent conductive electrodes 306 may be formed from materials such as, but not limited to, indium tin oxide (ITO). Each layer may serve a distinct function in facilitating the electrochromic process.

In embodiments, the electrochromic panel 102 includes two transparent conductive layers 306 positioned at the outermost surfaces of the panel 102. These layers may function as electrodes through which an electrical current is applied. The transparent nature of these conductive layers may allow light to pass through, ensuring minimal visual obstruction even if the panel 102 is in an opaque configuration.

In embodiments, the electrochromic panel 102 includes an electrochromic layer 308 positioned beneath the transparent conductive layers 306. The electrochromic layer 308 may be formed from electrochromic materials such as, but not limited to, tungsten oxide or viologens, which possess the ability to undergo reversible color changes in response to an applied electrical voltage. For instance, when a voltage is applied, ions within the electrochromic layer may migrate, causing a change in the absorption properties of the material and resulting in a shift in color or opacity.

In embodiments, the electrochromic panel 102 includes ion-conducting electrolyte layer 310 positioned between the electrochromic layer 308 and a counter electrode layer 312. For instance, the electrolyte layer 310 facilitates the movement of ions between the electrodes and the electrochromic layer 308 during the color-changing process. Further, the electrolyte layer 310 ensures efficient transport.

In embodiments, the electrochromic panel 102 includes a counter electrode layer 312. The counter electrode layer 312 completes the electrical circuit and helps to balance the charge during the electrochromic reaction. For instance, by providing a pathway for electron flow, the counter electrode 312 ensures the stability and reversibility of the color-changing process, enabling repeated cycles of tinting and clearing without degradation.

It is noted herein that the operation of electrochromic panels 102 is governed by the principles of electrochemistry and solid-state physics, wherein the application of an electrical voltage induces a reversible change in the optical properties of the electrochromic materials. For instance, when a low-voltage electrical current is applied to the transparent conductive electrodes 306, ions migrate within the electrochromic layer 308, causing the electrochromic material to undergo a change in color or opacity. This coloration process results in the darkening or tinting of the panel 102, reducing the transmission of light through the glass. Conversely, when the electrical voltage is removed or reversed, the electrochromic material reverts to its original state, leading to the gradual fading or clearing of the tinted panel 102. This bleaching process restores the transparency of the glass, allowing light to pass through unhindered.

In embodiments, the color change process is facilitated by the movement of ions between the electrodes 306 and the electrochromic layer 308, driven by the applied electrical potential. Additionally, the molecular structure of the electrochromic material undergoes reversible alterations during the coloration and bleaching processes, enabling repeated cycles of tinting and clearing without degradation.

In embodiments, the variable dimming electrochromic panel 102 is configured to provide dynamic control over the transparency and opacity of glass surfaces, providing significant benefits in privacy, energy savings, and cooling. For example, the electrochromic panel 102 may be configured to transition from complete transparency to complete dark out to enhance user comfort and optimize energy efficiency. One of the key features of the variable dimming electrochromic panel 102 is its ability to achieve a complete dark out tint level. In its fully opaque state, the panel 102 prevents any light from passing through, ensuring total privacy, which is particularly useful in environments like automotive windows or office meeting rooms where confidentiality and seclusion are paramount. Additionally, when fully darkened, the panel 102 significantly reduces solar heat gain, which lowers the demand on air conditioning systems and leads to substantial energy savings and enhanced cooling efficiency, especially in hot climates.

The operation of the electrochromic panel 102 is controlled by the controller 104 which is configured to regulate the application of electrical voltage to the electrodes 306. The controller 104 may be communicatively coupled to one or more light sensors to detect ambient light levels and automatically adjust the opacity of the panel 102 to maintain optimal interior conditions, temperature sensors to trigger the dark out mode to minimize heat gain, programmable timers for setting specific times for transitions between transparent and opaque states, and manual switches or touch interfaces for immediate user control.

It is noted herein that the adaptability of the electrochromic panel 102 makes it ideal for a wide range of applications across diverse industries such as, but not limited to, architectural glazing, automotive windows, aerospace cockpits, consumer electronics, and the like.

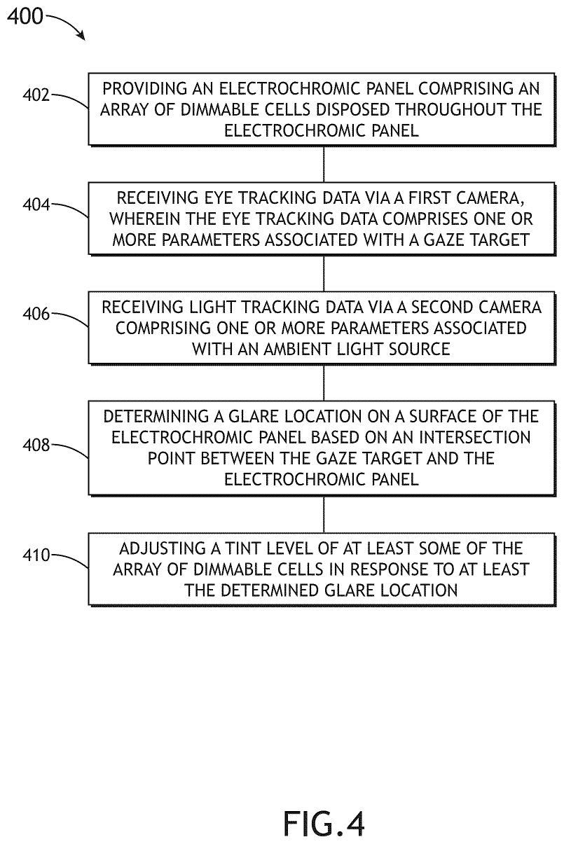

FIG. 4 illustrates a flowchart of a method for selectively modifying a tint level of an electrochromic panel 102, in accordance with one or more embodiments of the present disclosure. It is noted herein that the steps of the method may be implemented all or in part by the system 100. It is further recognized however, that the method is not limited to the system 100 in that additional or alternative system-level embodiments may carry out all or part of the steps of the method.

In a step 402, an electrochromic panel 102 comprising an array of dimmable cells is provided. For example, the array of dimmable cells may be disposed throughout the electrochromic panel 102. The electrochromic panel 102 may be configured to couple to at least a portion of a display such as, but not limited to, a window display (e.g., windshield), an instrumentation display, a multifunction display (MFD), a head-up display (HUD), a touchscreen display, an LED indicator panel, and the like.

In a step 404, eye tracking data is received via a first camera 110. For example, the eye tracking data may include one or more parameters associated with a gaze target of at least one pilot positioned within a cockpit of an aircraft. The one or more parameters associated with the gaze target may include, but are not limited to, a gaze direction, a gaze target location, a blink rate, or an eye movement pattern.

In a step 406, light tracking data is received via a second camera 112. For example, the light tracking data may include one or more parameters associated with an ambient light source. The one or more parameters associated with the ambient light source may include, but are not limited to, an intensity value of the ambient light source, a direction of light, a color temperature, and a position of the ambient light source relative to the aircraft.

In a step 408, a glare location is determined on at least a portion of the electrochromic panel 102. For example, the glare location may be determined based on an intersection point between the light source, the gaze target, and the electrochromic panel 102.

In a step 410, a tint level is selectively modified for at least some of the array of dimmable cells of the electrochromic panel 102. For example, the tint level may be selectively modified and/or adjusted between a range of zero percent up to 100 percent. By way of another example, a tint level may be modified in at least a portion of the electrochromic panel 102 based on the glare location.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system, comprising:
a first camera disposed within a cockpit of an aircraft, the first camera configured to at least track an eye movement of at least one pilot;
a second camera disposed within the cockpit of the aircraft, the second camera configured to at least track an ambient light source;
an electrochromic panel comprising an array of dimmable cells disposed throughout the electrochromic panel, wherein the electrochromic panel is configured to couple to at least a portion of a transparent or semi-transparent surface within the cockpit; and
a controller configured to modify the array of dimmable cells, the controller comprising one or more processors configured to execute program instructions stored in memory, wherein the program instructions are configured to cause the one or more processors to:
receive eye tracking data via the first camera, wherein the eye tracking data comprises one or more parameters associated with a gaze target of the at least one pilot positioned within the cockpit;
receive light tracking data via the second camera, wherein the light tracking comprises one or more parameters associated with the ambient light source;
determine a glare location on a surface of the panel where at least the gaze target intersects the panel, based on at least one of the received eye tracking data or the light tracking data; and
selectively modify a tint level of at least some of the array of dimmable cells in at least a portion of the panel in response to at least the determined glare location.

2. The system of claim 1, wherein the one or more parameters associated with the ambient light source include at least one of an intensity of the ambient light source, a direction of light, a color temperature, and a position of the ambient light source relative to the aircraft.

3. The system of claim 1, wherein the one or more parameters associated with the gaze target of the at least one pilot include at least one of a gaze direction, a gaze target location, a blink rate, or an eye movement pattern.

4. The system of claim 1, wherein the controller considers one or more additional parameters when modifying the array of dimmable cells, the one or more additional parameters including at least one of a cockpit layout, an aircraft orientation, an environmental condition, a pilot preference, or a flight phase.

5. The system of claim 1, wherein the controller is further configured to predict one or more glare locations on at least a portion of the panel and automatically modify at least some of the array of dimmable cells based on the predicted one or more glare locations.

6. The system of claim 5, wherein the prediction of the one or more glare locations is based on the position of the ambient light source and a projection of a flight path.

7. The system of claim 1, wherein the electrochromic panel is configured to cover an entire surface of a window.

8. The system of claim 1, wherein the electrochromic panel is configured to cover at least one segment of a window.

9. The system of claim 1, wherein the electrochromic panel comprises one or more pre-configuration modes including at least a 100 percent dim mode.

10. The system of claim 1, further comprising a head-up display (HUD) configured to project flight information onto a surface of a window, wherein the controller may modify the tint level of the array of dimmable cells to enhance the projected flight information of the HUD.

11. A method, comprising:
providing an electrochromic panel comprising an array of dimmable cells disposed throughout the electrochromic panel, wherein the electrochromic panel is configured couple to at least a portion of a transparent or semi-transparent surface within a cockpit;
receiving eye tracking data via a first camera, wherein the eye tracking data comprises one or more parameters associated with a gaze target of at least one pilot positioned within a cockpit of an aircraft;
receiving light tracking data via a second camera, wherein the light tracking data comprises one or more parameters associated with an ambient light source;
determining a glare location on a surface of the electrochromic panel based on at least an intersection point between the gaze target and the electrochromic panel; and
selectively modify a tint level of at least some of the array of dimmable cells in at least a portion of the panel in response to at least the determined glare location.

12. The method of claim 11, wherein the one or more parameters associated with the ambient light source include at least one of an intensity of the ambient light source, a direction of light, a color temperature, and a position of the ambient light source relative to the aircraft.

13. The method of claim 11, wherein the one or more parameters associated with the gaze target of the at least one pilot include at least one of a gaze direction, a gaze target location, a blink rate, or an eye movement pattern.

14. The method of claim 11, further comprising:
considering one or more additional parameters when modifying the array of dimmable cells, the one or more additional parameters including at least one of a cockpit layout, an aircraft orientation, an environmental condition, a pilot preference, or a flight phase.

15. The method of claim 11, further comprising:
predicting one or more glare locations on at least a portion of the panel and automatically adjusting at least some of the array of dimmable cells based on the predicted one or more glare locations.

16. The method of claim 15, wherein the prediction of the one or more glare locations is based on the position of the ambient light source and a projection of a flight path.

17. The method of claim 11, wherein the electrochromic panel is configured to cover an entire surface of a window.

18. The method of claim 11, wherein the electrochromic panel is configured to cover at least one segment of a window.

19. The method of claim 11, wherein the electrochromic panel comprises one or more pre-configuration modes including at least a 100 percent dim mode.

20. The method of claim 11, further comprising:
providing a head-up display (HUD) configured to project flight information onto a surface of a transparent or semi-transparent surface, wherein a tint level of the array of dimmable cells is adjusted to enhance the projected flight information of the HUD.
